(19) United States
(12) Patent Application Publication
(10) Pub. No.: US 2026/0027552 A1
(43) Pub. Date: Jan. 29, 2026

(54) AI2O3 NANORODS AND METHODS OF PRODUCING SAME

(71) Applicant: Neo Performance Materials (Singapore) Pte. Ltd., Singapore (SG)

(72) Inventors: Yong YAN, Singapore (SG); Yongying TAY, Singapore (SG); Szu Hwee NG, Singapore (SG)

(73) Assignee: Neo Performance Materials (Singapore) Pte. Ltd., Singapore (SG)

(21) Appl. No.: 18/996,688

(22) PCT Filed: May 24, 2024
(86) PCT No.: PCT/IB2024/055104

§ 371 Date: Jan. 17, 2025

Related U.S. Application Data
(60) Provisional application No. 63/504,500, filed on May 26, 2023.

(51) Int. Cl. B01J 21/04; B01J 35/40; B01J 35/61; B01J 37/00; B01J 37/02; B01J 37/03; B01J 37/04; B01J 37/08; B01J 37/34; C01F 7/34; C01F 7/441

(52) U.S. Cl. CPC B01J 21/04; B01J 35/40; B01J 35/613; B01J 35/615; B01J 37/009; B01J 37/0236; B01J 37/033; B01J 37/04; B01J 37/088; B01J 37/343; C01F 7/34; C01F 7/441; C01P 2002/72; C01P 2004/03; C01P 2004/16; C01P 2004/54; C01P 2004/61; C01P 2004/62; C01P 2004/64; C01P 2006/12

(57) ABSTRACT

Aluminum oxide particles of a nanorod morphology have beneficial properties for catalysis, filtration, purification, and other uses. Disclosed herein are nanosized aluminum oxide rod-shaped particles having an average particle length of about 50 nm to about 10 μm. These nanosized aluminum oxide particles have an aspect ratio of about 12 to about 25. The aluminum oxide particles also have a BET surface area of about 10 m²/g to about 200 m²/g. Further disclosed are processes of producing these nanosized aluminum oxide rod-shaped particles. The aluminum oxide particles as disclosed herein with moderate aspect ratios provide significant advantages as catalyst supports due to their increased surface area, improved mass transfer, excellent thermal stability, and high mechanical strength.

### CROSS-REFERENCE TO RELATED APPLICATION

This application is being filed on 24 May 2024, as a PCT International Application and claims the benefit of and priority to U.S. Provisional Patent Application No. 63/504,500 filed on 26 May 2023, the disclosure of which is hereby incorporated by reference in its entirety.

### FIELD OF THE INVENTION

This application relates to compositions of nanosized aluminum oxide particles having an average particle length of about 50 nm to about 10 μm, an aspect ratio of about 12 to about 25, and a BET surface area of about 10 to about 200 m²/g, and to processes of producing these compositions and uses for same.

### INTRODUCTION

Nanosized aluminum oxide generally occurs in the form of spherical or nearly spherical nanoparticles or in the form of oriented or undirected fibers. Nanosized spherical properties have high surface areas, crystallinity, and pore sizes that make them suitable for filtration applications, capturing impurities from air/exhaust, bioimaging and biosensing, desiccants, and sorbents. In contrast, one-dimensional (1D) nanostructured materials, including nanotubes, nanofibers, nanorods, nanowires etc. have a high degree of orientation, large surface area, facile strain relaxation upon cycling, and efficient electron transport pathway. As such, applications of nanofibers are used in high temperature insulation, catalyst supports, polymer composite reinforcement, and microelectronics.

It is desirable to develop additional morphologies or shapes for aluminum nanoparticles that maintain the physical characteristics of the spherical or nearly spherical nanoparticles while exploring the other unique properties of 1-D nanomaterials. The interlace of 1-D particles into 3-D (three-dimensional) structure with interlinked muti-channels will be of great benefits for catalytic applications. Rod-shaped particles with a moderate aspect ratio have the potential to increase surface area and provide better dispersion of supported active components that benefits the above-described uses. Specifically, high surface areas provide more active sites for reactions, adsorption, and interactions with other materials.

Increasing efforts have been devoted to the preparing aluminum oxide particles with advantageous shapes and physical properties, such as rod-shaped particles.

### SUMMARY

Aluminum oxide particles of a nanorod morphology have beneficial properties for catalysis, filtration, purification, and other uses. As disclosed herein, the present compositions comprise nanosized aluminum oxide particles, wherein the particles have an average particle length of about 50 nm to about 10 μm, an aspect ratio of about 12 to about 25, and a BET surface area of about 10 m²/g to about 200 m²/g. In particular embodiments, the average particle length is from about 0.2 μm to about 4 μm. In other particular embodiments, the particles have a particle width of about 10 nm to about 250 nm. And in further embodiments, the particles have an aspect ratio of about 15 to about 22. Any of these particular embodiments may be combined individually or cumulatively.

Further disclosed herein are processes of producing aluminum oxide nanorod particles. These processes comprise (a) dissolving an aluminum precursor, precipitant, and optionally a polymeric additive in water to provide a solution, wherein the aluminum precursor is an aluminum nitrate, an aluminum chloride, or mixture thereof and the precipitant is selected from the group consisting of urea, NaOH, KOH, NH₃·H₂O, and mixtures thereof; (b) mixing the solution; (c) hydrothermally reacting the solution at a temperature of about 80° C. to about 200° C. for about 1 hour to about 24 hours to create a slurry; (d) collecting precipitates from the slurry; and (e) calcining the precipitates at a temperature of about 500° C. to about 1000° C. for about 1 hour to about 6 hours to provide the aluminum oxide nanorod particles having an average particle length of about 50 nm to about 10 μm and an aspect ratio of about 12 to about 25.

### BRIEF DESCRIPTION OF THE DRAWINGS

FIG. 1 illustrates a flowchart of an embodiment of the process of making the Al₂O₃ nanorod compositions.

FIG. 2A is a SEM of the Al₂O₃ particles of Comparative Example 1.

FIG. 2B is an x-ray powder diffractogram (XRPD) of the Al₂O₃ particles of Comparative Example 1, after calcining, and shows characteristics of pseudo boehmite.

FIG. 3A is a SEM of the Al₂O₃ particles of Comparative Example 2.

FIG. 3B is an x-ray powder diffractogram (XRPD) of the Al₂O₃ particles of Comparative Example 2, after calcining, and shows characteristics of γ-Al₂O₃.

FIG. 4A is a SEM of the Al₂O₃ particles of Example 1.

FIG. 4B is an x-ray powder diffractogram (XRPD) of the Al₂O₃ particles of Example 1, after calcining, and shows characteristics of γ-Al₂O₃.

FIG. 5A is a SEM of the Al₂O₃ particles of Example 2.

FIG. 5B is an x-ray powder diffractogram (XRPD) of the Al₂O₃ particles of Example 2, after calcining, and shows characteristics of δ-Al₂O₃.

FIG. 6A is a SEM of the Al₂O₃ particles of Example 3.

FIG. 6B is an x-ray powder diffractogram (XRPD) of the Al₂O₃ particles of Example 3, after calcining, and shows characteristics of γ-Al₂O₃.

FIG. 7A is a SEM of the Al₂O₃ particles of Example 4.

FIG. 7B is an x-ray powder diffractogram (XRPD) of the Al₂O₃ particles of Example 4, after calcining, and shows characteristics of δ-Al₂O₃.

FIG. 8A is a SEM of the Al₂O₃ particles of Example 5.

FIG. 8B is an x-ray powder diffractogram (XRPD) of the Al₂O₃ particles of Example 5, after calcining, and shows characteristics of γ-Al₂O₃.

### DETAILED DESCRIPTION

Before the compositions having nanosized aluminum oxide particles and

processes are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” or “approximately” include typical experimental variances and these two terms are used interchangeably. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

Disclosed herein in a composition comprising nanosized aluminum oxide particles having an average particle length of about 50 nm to about 10 μm, an aspect ratio of about 12 to about 25, and a BET surface area of about 10 m²/g to about 200 m²/g. These particles are rod-shaped and thus may also be called nanorod aluminum oxide particles. As such, these aluminum oxide particles have a moderate aspect ratio. The alumina oxide particles with the above-properties provide significant advantages as catalyst supports due to their increased surface area, improved mass transfer, excellent thermal stability, and high mechanical strength.

As described herein, aspect ratio means the ratio between the average particle length and the average particle width. The average particle length, width, and size are measured using Scanning Electron Microscopy. As described herein, at least 50 particles are measured by SEM to calculate these average values.

The particles as described herein have an aspect ratio of about 12 to about 25. As defined herein, particles having this aspect ratio of about 12 to about 25 are “nanorods”, rather than particles of other morphologies or shapes (i.e., spherical, nearly spherical, fibers, etc.). This nanorod shape of the disclosed particles have more surface area because they are longer and stretched out and maintain physical properties of crystallinity and pores which make them suitable for use as supports for catalytic materials.

The particles disclosed herein exhibit a moderate aspect ratio of about 12 to about 25, defining them as a “nanorod’ versus a morphology that would have an aspect ratio less than 12 or an aspect ratio larger than 25. 1-D nanostructured materials with an aspect ratio less than 12 will not be able to construct a desired interlinked structure for catalytic applications. Higher aspect ratio 1-D materials possess safety hazards of causing asbestos-like lung cancer and mesothelioma.

As described herein, the nanosized aluminum oxide particles have a BET surface area of about 10 m²/g to about 200 m²/g. The BET surface area of the compositions was determined by using a Micromeritics Tristar II system and nitrogen at about 77 Kelvin. In compliance with commonly accepted procedures in the determination of surface area as used herein, the application of the BET equation was limited to the pressure range where the term na(1−P/Po) of the equation continuously increases with P/Po. The out gassing of the sample was done under nitrogen at about 350 degrees Celsius for about 2 hours.

In certain embodiments, the aluminum oxide particles may have an average particle length is from about 0.2 μm to about 4 μm. In particular embodiments, the aluminum oxide particles may have an average particle width of about 10 nm to about 250 nm. In further embodiments, the aluminum oxide particles may have an aspect ratio of about 15 to about 22. These embodiments of average particle length, width, and aspect ratio may be individually or cumulatively combined with any of the embodiments of the aluminum oxide particles as described supra.

In some embodiments, the aluminum oxide particles are crystalline. The aluminum oxide may be δ-alumina, γ-alumina, or boehmite. In embodiments where the aluminum oxide is δ-alumina, the composition may have a Loss on Ignition (LOI) of about 0.2% to about 8%. In embodiments where the aluminum oxide is γ-alumina, the composition may have a Loss on Ignition (LOI) of about 0.2% to about 15%. In embodiments where the aluminum oxide is boehmite, the composition may have a Loss on Ignition (LOI) of about 0.2% to about 30%. As described herein, LOI was measured by determining the sample mass before and after calcination of the products at 1000° C. for 1 h. These crystalline embodiments and LOI may be combined with any of the embodiments described supra.

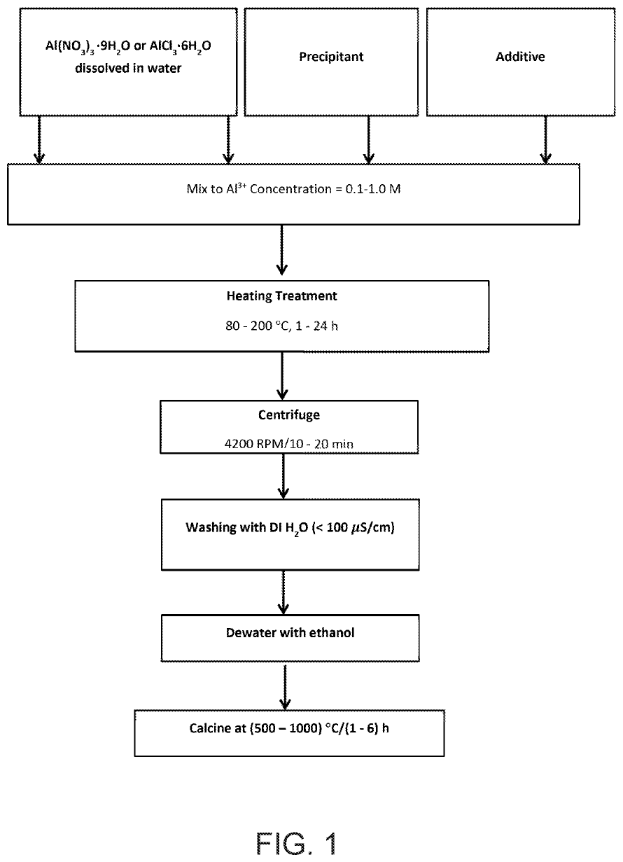

The nanosized aluminum oxide particles disclosed herein are made by a particular process that provides the nanosized aluminum oxide particles having an average particle length of about 50 nm to about 10 μm, an aspect ratio of about 12 to about 25, and a BET surface area of about 10 m²/g to about 200 m²/g. FIG. 1 is a flow chart for an embodiment of a process of producing the nanosized aluminum oxide particles as described herein.

This process includes steps of (a) dissolving an aluminum precursor, precipitant, and optionally a polymeric additive in water to provide a solution, wherein the aluminum precursor is an aluminum nitrate, an aluminum chloride, or mixture thereof and the precipitant is selected from the group consisting of urea, NaOH, KOH, NH₃·H₂O, and mixtures thereof; (b) mixing the solution; (c) hydrothermally reacting the solution at a temperature of about 80° C. to about 200° C. for about 1 hour to about 24 hours to create a slurry; (d) collecting precipitates from the slurry; and (c) calcining the precipitates at a temperature of about 500° C. to about 1000° C. for about 1 hour to about 6 hours to provide the aluminum oxide nanorod particles. As described, these aluminum oxide nanorod particles have an average particle length of about 50 nm to about 10 um and an aspect ratio of about 12 to about 25.

The disclosed process provides the nanosized aluminum oxide particles as disclosed and described above.

In step (a) the aluminum precursor, precipitant, and optionally the polymeric additive are dissolved in water to provide a solution. The order of addition is not important, and any order of addition may be utilized. Additionally, the components may be dissolved in water to form solutions independently and then the solutions combined. In certain embodiments, the aluminum precursor is dissolved in water first and then the precipitant and optional polymeric additive are then added to and dissolved in this solution. In other embodiments, the aluminum precursor and optional polymeric additive are dissolved in water; the precipitant is independently dissolved in water; and then the two solutions are combined to provide the solution of (a) containing the aluminum precursor, precipitant, and optional polymeric additive.

In certain embodiments, the aluminum precursor is Al(NO₃)₃·9H₂O or AlCl₃·6H₂O. In particular of these embodiments, the aluminum precursor is Al(NO₃)₃·9H₂O with an oxide content of about 13.4% or AlCl₃·6H₂O with an oxide content of about 21.1%.

In certain embodiments, the precipitant is urea, NaOH, KOH, or NH₃·H₂O. In certain of these embodiments, the precipitant is urea. In particular of these embodiments, the aluminum precursor and urea precipitant are dissolved in water.

In embodiments utilizing the polymeric additive, the polymeric additive is selected from a group consisting of cetrimonium bromide, cetrimonium chloride, sodium dodecyl sulfate, polyethylene glycol, and mixtures thereof. In certain embodiments utilizing the polymeric additive, the polymeric additive is sodium dodecyl sulfate or cetrimonium bromide and the precipitant is urea. In particular of the embodiments utilizing the polymeric additive, the aluminum precursor, precipitant, and polymeric additive are dissolved in water.

In embodiments, the aluminum precursor may be dissolved in a concentration of about 1 g/10 mL to about 5 g/10 mL. In certain of these embodiments, the precipitant may be dissolved in a concentration of about 1 g/10 mL to about 6 g/10 mL.

The solution of step (a) is then mixed. The solution may be mixed by stirring for about 30 minutes to about 12 hours. In other embodiments, the solution may be mixed by sonication, and then by stirring. In additional embodiments, the sonication step may be omitted and only stirring is utilized.

In certain embodiments, the Al³⁺ concentration of the solution of step (b) is about 0.1 to about 1.0 M.

The mixed solution of step (b) is then hydrothermally reacted at a temperature of about 80° C. to about 200° C. for about 1 hour to about 24 hours to create a slurry (identified as step (c) of the process as described herein).

In certain embodiments, the slurry of step (c) may be aged in deionized water or ethanol before precipitants from the slurry are collected (in step (d) of the process as described herein).

The precipitates may be collected by filtration or centrifugation. In certain embodiments, the collected precipitates may be washed with deionized water to a conductivity of less than about 100 μS/cm. In embodiments, the collected precipitates may be dewatered, especially in the embodiments in which the collected precipitates are washed with deionized water. In embodiments including dewatering, the collected precipitates may be dewatered with ethanol. In embodiments including washing with water and/or dewatering, the process may further include drying the precipitants at about 50° C. to about 100° C. for about 3 hours to about 12 hours before calcining (in step (e) of the process as described herein).

Finally, the precipitates are calcined at a temperature of about 500° C. to about 1000° C. for about 1 hour to about 6 hours to provide the aluminum oxide nanorod particles as described herein. The calcining should be sufficient to remove the polymeric additive. In particular embodiments, the precipitants are calcined at about 900° C. for about 1 hour.

The process as described herein provides the aluminum oxide nanorod particles.

These aluminum oxide nanorod particles may be used as catalyst supports and due to their advantageous physical properties (including the aspect ratio of about 12 to about 25), these particles provide significant advantages as catalyst supports due to their increased surface area, improved mass transfer, excellent thermal stability, and high mechanical strength. These properties contribute to more efficient and durable catalytic systems, making the aluminum oxide particles as disclosed herein highly valuable in various industrial catalytic applications. These catalytic applications include, for example, lithium ion batteries, photocatalysts, filtration applications, and the like.

FIG. 1 is a flow chart for an embodiment of a process of producing aluminum oxide nanorod particles, as illustrated below in the examples that follow.

In the following, Examples are given to illustrate the inventive method for the preparation of aluminum oxide nanorod particles and characterization thereof in more detail, although the scope of the invention is never limited thereby in any way.

In the following examples, a JEOL JSM6010LV was used to take SEM (Scanning Electron Microscope) images to determine the average particle size and morphology. As used herein, aspect ratio is defined as the ratio between the average particle length and the average particle width. The particles disclosed herein exhibit a consistent width along the length of each particle. For each measurement, at least 50 particles were measured under SEM to calculate the average values. A Malvern Panalytical Empyrean X-ray diffractometers was used to determine the crystalline structures of the final products. A Micromeritics Tristar was used to determine the specific surface area (SSA) of the final products. Finally, a muffle furnace was used to determine the LOI by calcining the sample at 1000° C. for 1 hour.

The comparative examples disclosed herein depict particles with a slightly shortened shape, and a broadened width. The smaller aspect ratio of the particles produced by the comparative examples makes them less desirable than the aluminum oxide nanorod particles as described herein.

The aluminum oxide nanorod particles as described herein have a moderate aspect ratio of about 12 to about 25. These particles also have a BET surface area of about 10 m²/g to about 200 m²/g. The physical characteristics of the aluminum oxide nanorod particles as described herein (including the aspect ratio and BET surface area) provide significant advantages as catalyst supports due to their increased surface area, improved mass transfer, excellent thermal stability, and high mechanical strength. These properties contribute to more efficient and durable catalytic systems, making the aluminum oxide nanorods as disclosed herein highly valuable in various industrial catalytic applications.

The aluminum oxide nanorod particles with an aspect ratio of about 12 to about 25 have a larger surface area compared to aluminum oxide particles with lower aspect ratios. This increased surface area provides more active sites for catalytic reactions, leading to improved catalyst performance. The aspect ratio of about 12 to about 25 also provides channels that facilitate the diffusion of reactants and products to and from the active sites.

The aluminum oxide nanorod particles as disclosed herein also exhibit excellent thermal stability when the aspect ratio is about 12 to about 25, maintaining the catalyst's high surface area and activity over extended periods. This property is crucial for catalytic processes that operate under severe thermal conditions, ensuring the longevity and reliability of the catalyst.

The aluminum oxide nanorod particles as disclosed further possess high mechanical strength, which helps in preserving the structural integrity of the catalyst support under various mechanical stresses. This durability is beneficial for industrial applications where catalysts are subject to physical wear and tear.

### Comparative Example 1

The following was done:
1) 19.6 g Al(NO₃)₃·9H₂O (Oxide content=13.4%) was weighed and dissolved in 140 ml DI water.
2) 4.5 mL ethylenediamine was added into the above solution.
3) The mixture was stirred for 60 minutes.
4) The mixture was transferred into a 200 mL hydrothermal reactor.
5) The mixture was hydrothermally treated at 200° C. for 24 hours.
6) The precipitates were collected by centrifugation and washed with DI water to achieve a conductivity of less than 100 μS/cm.
7) The solid was dewatered with ethanol for three washes to obtain a wetcake.
8) The wetcake was dried at 80° C. for 2 hours.

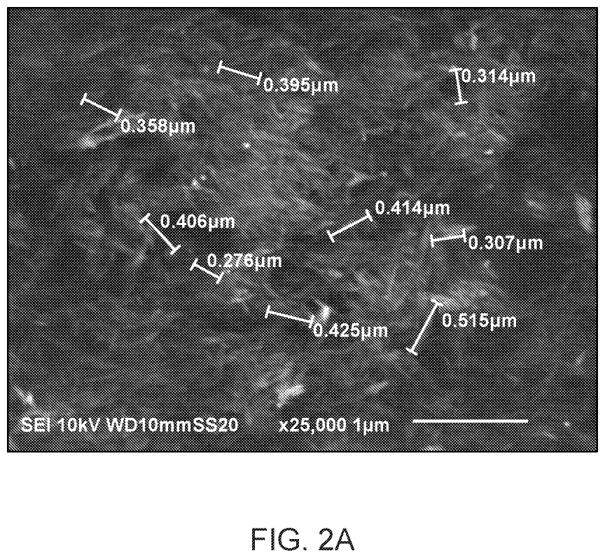

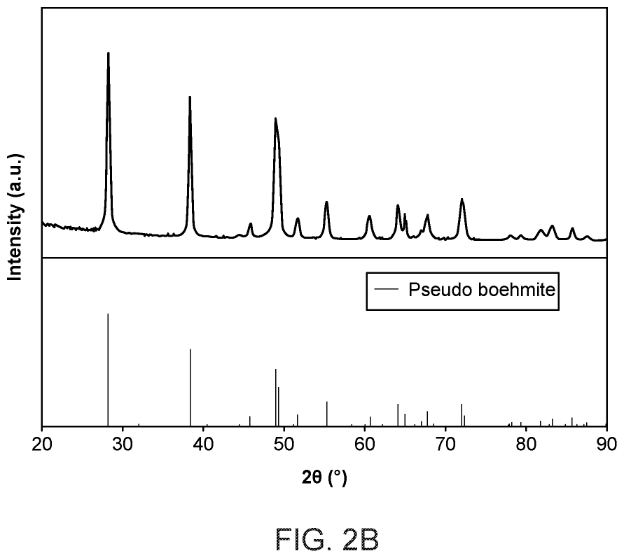

The Al₂O₃ particles of Comparative Example 1 had a slightly shortened shape. The Al₂O₃ particles were examined by scanning electron microscopy (SEM) (FIG. 2A). The Al₂O₃ particles had an average length of about 523 nm and an average width of about 53 nm and an aspect ratio of ˜9.9. The Al₂O₃ particles had a surface area of about 73.5 m²/g, and a LOI of 18.3%. The calcined product was analyzed by XRPD and showed characteristics of pseudo-boehmite (FIG. 2B).

TABLE 1
Characteristics of Comparative Example 1

| SSA | 73.5 m²/g |
|---|---|
| LOI | 18.3% |

### Comparative Example 2

The following was done:
(1) 19.2 g Al₂(SO₄)₃·XH₂O (Oxide content=16.6%) was weighed and dissolved in 100 mL DI water.
(2) 38.4 g urea was added into the above solution.
(3) The mixture was stirred for 1 h.
(4) The mixture was then transferred into a 200 mL hydrothermal reactor.
(5) Hydrothermally treated the mixture at 180° C. for 4 h.
(6) The precipitates were collected by centrifugation and washed with deionized water to achieve a conductivity of less than 100 μS/cm.
(7) The solid was dewatered with ethanol for three wash to obtain a wetcake.
(8) The wetcake was dried at 60° C. overnight.
(9) The dried products were calcined at 900° C. for 1 h.

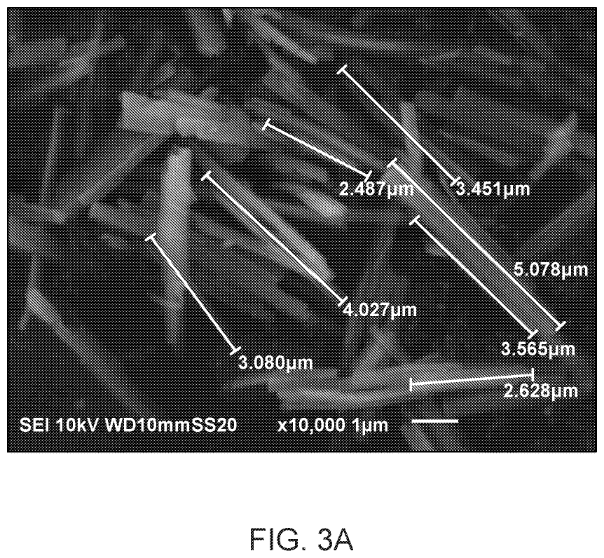

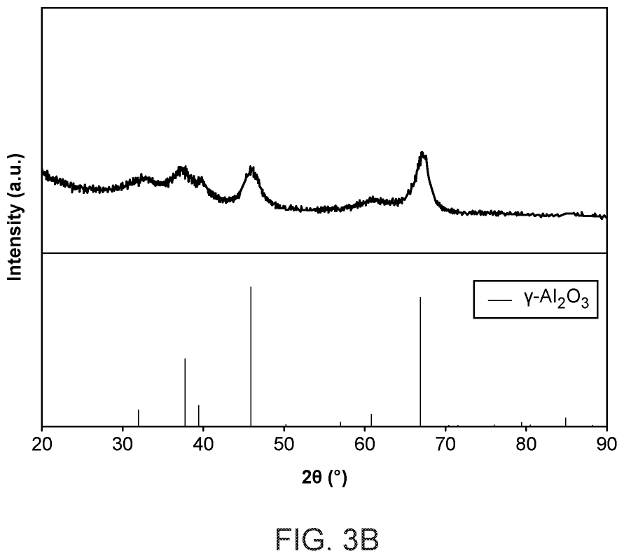

The Al₂O₃ particles of Comparative Example 2 had a slightly thickened shape. The Al₂O₃ particles were examined by scanning electron microscopy (SEM) (FIG. 3A). The Al₂O₃ particles had an average length of about 4.678 μm and an average width of about 514 nm and an aspect ratio of ˜9.1. The Al₂O₃ particles had a surface area of about 181.5 m²/g, and a LOI of 11.9%. The calcined product was analyzed by XRPD and showed characteristics of γ-Al₂O₃ (FIG. 3B).

TABLE 2
Characteristics of Comparative Example 2

| SSA | 181.5 m²/g |
|---|---|
| LOI | 11.9% |

### Example 1: Making ˜3 μm Al₂O₃ Nanorods

The following was done:
1) 20 g Al(NO₃)₃·9H₂O (Oxide content=13.4%) was weighed and dissolved in 100 mL DI water.
2) 38.4 g urea was weighed and added into the above solution.
3) The mixture was stirred for 60 minutes.
4) The mixture was transferred into a 200 mL hydrothermal reactor.
5) The mixture was hydrothermally treated at 180° C. for 7 hours.
6) The precipitates were collected by centrifugation and washed with DI water to achieve a conductivity of less than 100 μS/cm.
7) The solid was dewatered with ethanol for three washes to obtain a wetcake.
8) The wetcake was dried at 60° C. overnight.
9) The dried products were calcined at 900° C. for 1 hour.

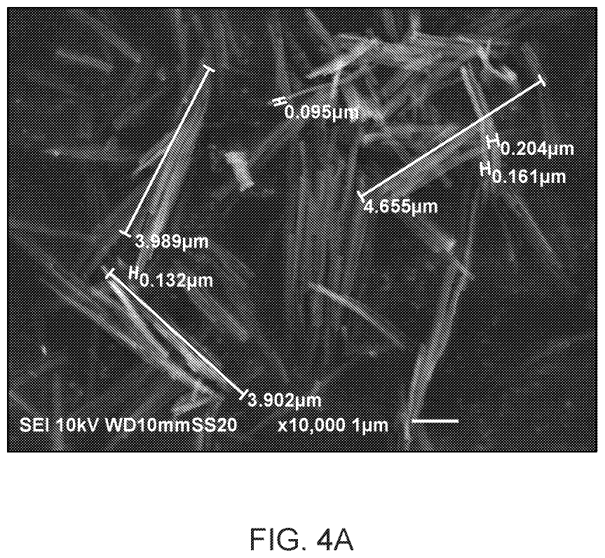

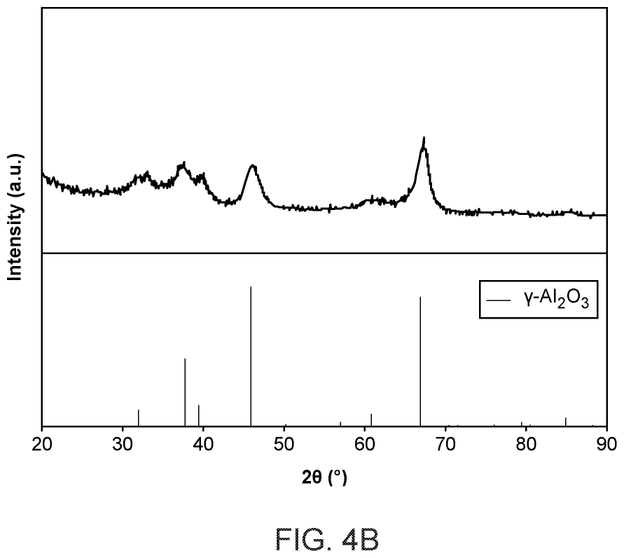

The Al₂O₃ particles had a rodlike shape as defined herein. The Al₂O₃ particles were examined by scanning electron microscopy (SEM) and the alumina oxide comprised particles with a rodlike shape and an average length of about 2.663 μm, and an average width of about 170 nm (FIG. 4A). The particle size analysis of these Al₂O₃ particles showed that the particles had a surface area of about 169.1 m²/g, and an aspect ratio of ˜15.6. The calcined product was analyzed by XRPD and showed the characteristics of the γ-Al₂O₃ (FIG. 4B).

TABLE 3
Characteristics of Example 1

| SSA | 169.1 m²/g |
|---|---|
| LOI | 5.04% |

### Example 2: Making ˜2 μm Al₂O₃ Nanorods

The following was done:
1) 10 g Al(NO₃)₃·9H₂O (Oxide content=13.4%) was weighed and dissolved in 100 mL DI water.
2) 19.2 g urea was weighed and added into the above solution.
3) 2.5 g sodium dodecyl sulfate was weighed and added into the above solution.
4) The mixture was stirred for 60 min.
5) The mixture was transferred into a 200 mL hydrothermal reactor.
6) The mixture was hydrothermally treated at 180° C. for 4 hours.
7) The precipitates were collected by centrifugation and washed with DI water to achieve a conductivity of less than 100 μS/cm.
8) The solid was dewatered with ethanol for three washes to obtain a wetcake.
9) The wetcake was dried at 60° C. overnight.
10) The dried products were calcined at 900° C. for 1 hour.

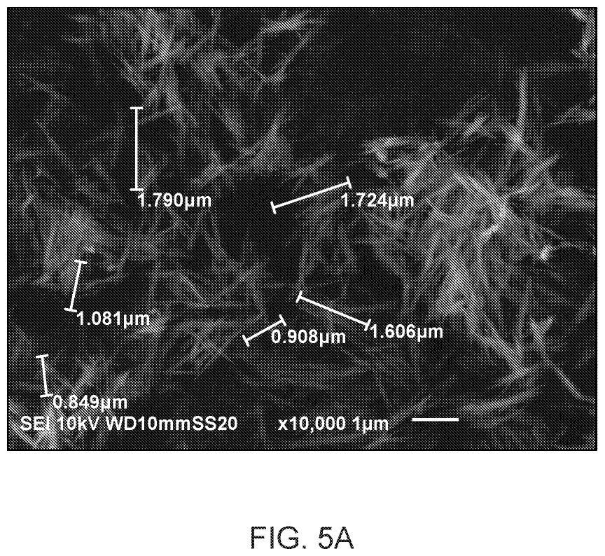

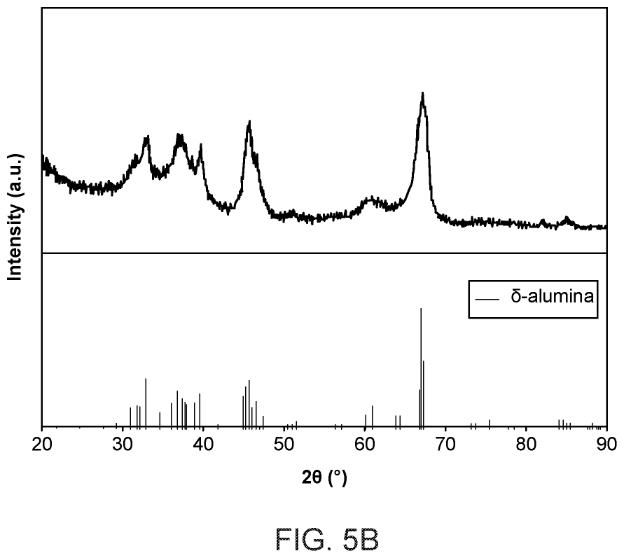

The Al₂O₃ particles had a rodlike shape as defined herein. The Al₂O₃ particles were examined by scanning electron microscopy (SEM) and the alumina oxide comprised particles with a rodlike shape and an average length of about 1.345 μm, and an average width of about 81 nm (FIG. 5A). The particle size analysis of these Al₂O₃ particles showed that the particles had a surface area of about 114.9 m²/g, and an aspect ratio of ˜16.6. The calcined product was analyzed by XRPD and showed the characteristics of the δ-Al₂O₃(FIG. 5B).

TABLE 4
Characteristics of Example 2

| SSA | 114.9 m²/g |
|---|---|
| LOI | 6.74% |

### Example 3: Making ˜3 μm Al₂O₃ Nanorods

The following was done:
(1) 12.9 g AlCl₃·6H₂O (Oxide content=21.1%) was weighed and dissolved in 100 mL DI water.
(2) 38.4 g urea was added into the above solution.
(3) The mixture was stirred for 60 min.
(4) The mixture was transferred into a 200 mL hydrothermal reactor.
(5) Hydrothermally treat the mixture at 180° C. for 4 h.
(6) The precipitates were collected by centrifugation and washed with deionized water to achieve a conductivity of less than 100 μS/cm.
(7) The solid was dewatered with ethanol for three wash to obtain a wetcake.
(8) The wetcake was dried at 60° C. overnight.
(9) The dried products were calcined at 900° C. for 1 h.

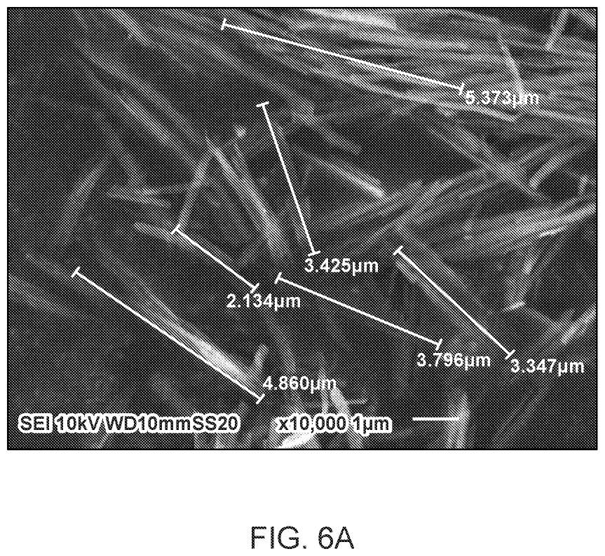

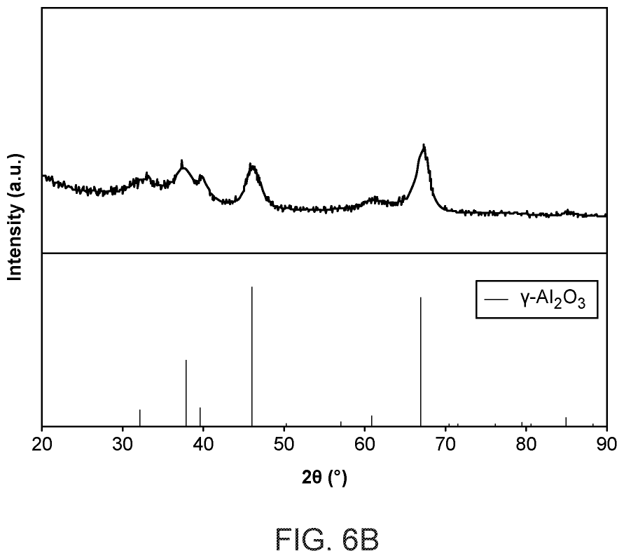

The Al₂O₃ particles had a rodlike shape as defined herein. The Al₂O₃ particles were examined by scanning electron microscopy (SEM) and the alumina oxide comprised particles with a rodlike shape and an average length of about 3.567 μm, and an average width of about 230 nm (FIG. 6A). The particle size analysis of these Al₂O₃ particles showed that the particles had a surface area of about 167.2 m²/g, and an aspect ratio of ˜15.5. The calcined product was analyzed by XRPD and showed the characteristics of the γ-Al₂O₃ (FIG. 6B).

TABLE 5
Characteristics of Example 3

| SSA | 167.2 m²/g |
|---|---|
| LOI | 10.2% |

### Example 4: Making ˜800 nm Al₂O₃ nanorods

The following was done:
(1) 20 g Al(NO₃)₃·9H₂O (Oxide content=13.4%) and 5 g CTAB (Cetrimonium bromide) were weighed and dissolved in 200 mL DI water.
(2) 38.4 g urea was weighed and dissolved in 150 mL DI water.
(3) Both solutions were sonicated for 1 h.
(4) Both solutions were then filtered after stirring overnight.
(5) The two solutions were mixed and stirred for 1 h.
(6) The mixture was then transferred into a 500 mL hydrothermal reactor.
(7) Hydrothermally treated the mixture at 180° C. for 4 h.
(8) The precipitates were collected by centrifugation and washed with deionized water to achieve a conductivity of less than 100 μS/cm.
(9) The solid was dewatered with ethanol for three wash to obtain a wetcake.
(10) The wetcake was dried at 60° C. overnight.
(11) The dried products were calcined at 900° C. for 1 h.

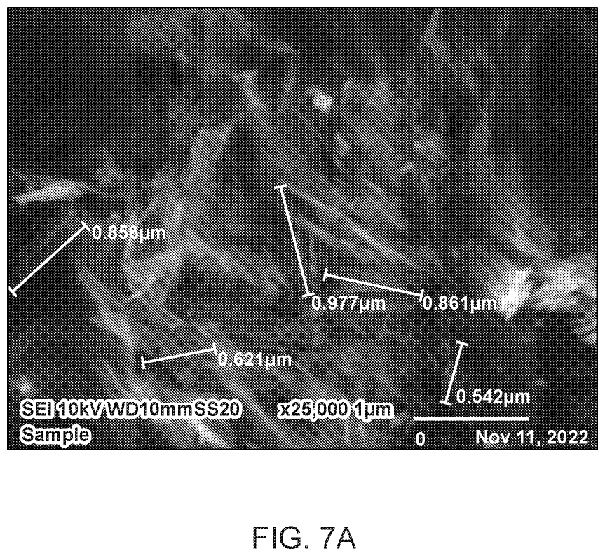

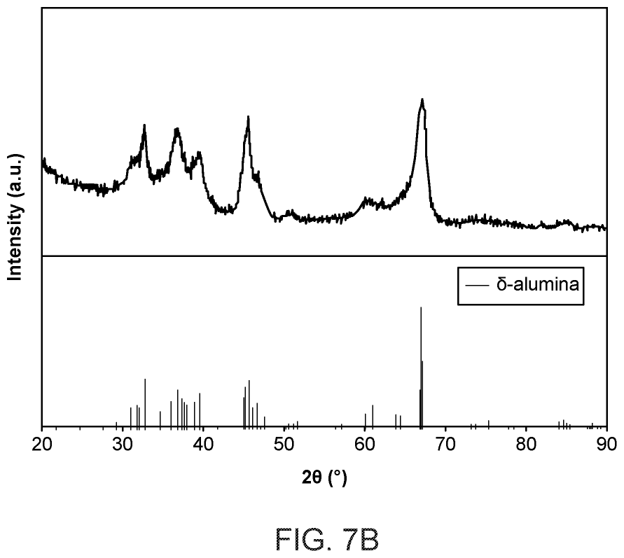

The Al₂O₃ particles had a rodlike shape as defined herein. The Al₂O₃ particles were examined by scanning electron microscopy (SEM) and the alumina oxide comprised particles with a rodlike shape and an average length of about 824 nm, and an average with of about 40 nm. (FIG. 7A). The particle size analysis of these Al₂O₃ particles showed that the particles had a surface area of about 99.0 m²/g, and an aspect ratio of ˜ 20.6. The calcined product was analyzed by XRPD and showed the characteristics of the δ-Al₂O₃(FIG. 7B).

TABLE 6
Characteristics of Example 4

| SSA | 99.0 m²/g |
|---|---|
| LOI | 2.76% |

### Example 5: Making ˜2 μm Al₂O₃ Nanorods

The following was done:
(1) 30 g Al(NO₃)₃·9H₂O (Oxide content=13.4%) was weighed and dissolved in 100 mL DI water.
(2) 57.6 g urea was added into the above solution.
(3) The mixture was stirred for 1 h.
(4) The mixture was then transferred into a 200 mL hydrothermal reactor.
(5) Hydrothermally treated the mixture at 180° C. for 4 h.
(6) The precipitates were collected by centrifugation and washed with deionized water to achieve a conductivity of less than 100 μS/cm.
(7) The solid was dewatered with ethanol for three wash to obtain a wetcake.
(8) The wetcake was dried at 60° C. overnight.
(9) The dried products were calcined at 900° C. for 1 h.

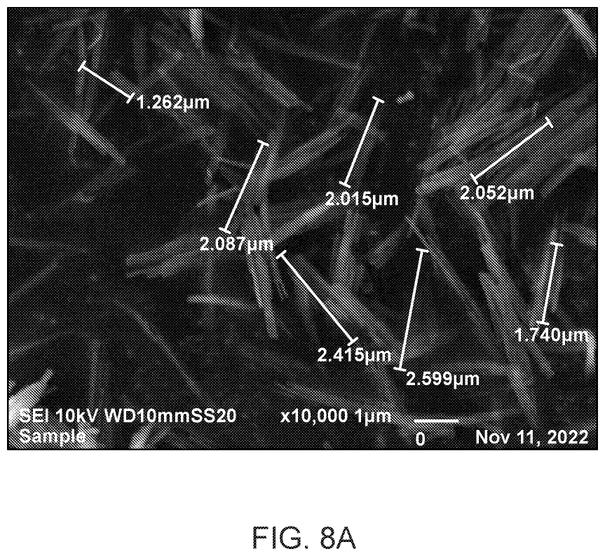

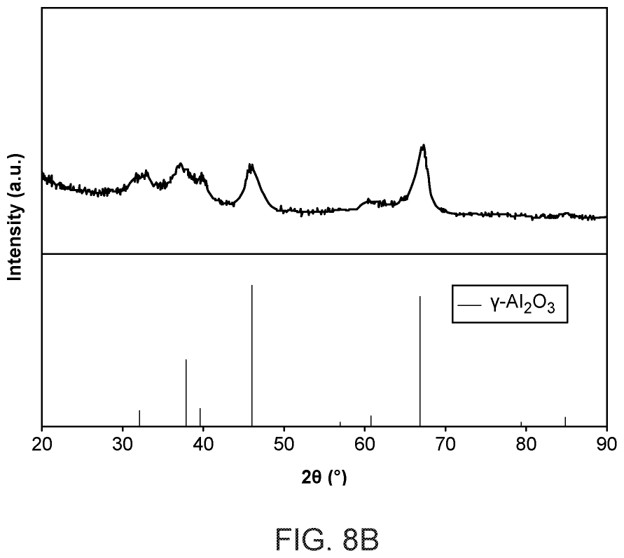

The Al₂O₃ particles had a rodlike shape as defined herein. The Al₂O₃ particles were examined by scanning electron microscopy (SEM) and the alumina oxide comprised particles with a rodlike shape and an average length of about 1.684 μm, and an average width of about 102 nm (FIG. 8A). The particle size analysis of these Al₂O₃ particles showed that the particles had a surface area of about 149.5 m²/g, and an aspect ratio of ˜16.5. The calcined product was analyzed by XRPD and showed the characteristics of the γ-Al₂O₃ (FIG. 8B).

TABLE 7
Characteristics of Example 5

| SSA | 149.5 m²/g |
|---|---|
| LOI | 2.41% |

### Summary of Aspect Ratios for Examples vs Comparative Examples

The following table summarizes the aspect ratios for Al₂O₃ nanorod particles in comparison to the Al₂O₃ particles of the comparative examples. As disclosed, the Al₂O₃ nanorod particles have an aspect ratio of about 12 to about 25.

The results confirm that the comparative examples made Al₂O₃ particles with significantly smaller (and less desirable) aspect ratios.

TABLE 8
Comparison of the Aspect Ratio

| | Length by SEM | Width by SEM | |
|---|---|---|---|
| Ex. Number | (nm) | (nm) | Aspect Ratio |
| 1 | ~2663 | ~170 | 15.6 |
| 2 | ~1345 | ~81 | 16.6 |
| 3 | ~3567 | ~230 | 15.5 |
| 4 | ~824 | ~40 | 20.6 |
| 5 | ~1684 | ~102 | 16.5 |
| CP 1 | ~523 | ~53 | 9.9 |
| CP 2 | ~4678 | ~514 | 9.1 |

CP: Comparative

As shown, the Al₂O₃ nanorod particles as disclosed herein have an aspect ratio of about 12 to about 25, and in particular embodiments, about 15 to about 22. In contrast, the Al₂O₃ particles of the comparative examples have a measurably smaller aspect ratio, indicating that their morphology/shape is not as desirable.

The physical characteristics of the Al₂O₃ nanorod particles as described herein (including the aspect ratio and BET surface area) provide significant advantages as catalyst supports due to their increased surface area, improved mass transfer, excellent thermal stability, and high mechanical strength. These properties contribute to more efficient and durable catalytic systems, making the Al₂O₃ nanorod particles of the present invention highly valuable in various industrial catalytic applications.

The Al₂O₃ nanorod particles with an aspect ratio of about 12 to about 25 have a larger surface area compared to Al₂O₃ nanorod particles of the Comparative Examples with lower aspect ratios. This increased surface area provides more active sites for catalytic reactions, leading to improved catalyst performance. The aspect ratio of the present Al₂O₃ nanorod particles also provides channels that facilitate the diffusion of reactants and products to and from the active sites.

The Al₂O₃ nanorod particles as disclosed herein also exhibit excellent thermal stability, maintaining the catalyst's high surface area and activity over extended periods. This property is crucial for catalytic processes that operate under severe thermal conditions, ensuring the longevity and reliability of the catalyst.

The Al₂O₃ nanorod particles as disclosed further possess high mechanical strength, which helps in preserving the structural integrity of the catalyst support under various mechanical stresses. This durability is beneficial for industrial applications where catalysts are subject to physical wear and tear.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A composition comprising nanosized aluminum oxide particles, wherein the particles have an average particle length of about 50 nm to about 10 μm, an aspect ratio of about 12 to about 25, and a BET surface area of about 10 m²/g to about 200 m²/g.

2. The composition of claim 1, wherein the aluminum oxide is δ-alumina, γ-alumina, or boehmite.

3. The composition of claim 2, wherein the aluminum oxide is δ-alumina and the composition has a Loss on Ignition (LOI) of about 0.2% to about 8%.

4. The composition of claim 2, wherein the aluminum oxide is γ-alumina and the composition has a Loss on Ignition (LOI) of about 0.2% to about 15%.

5. The composition of claim 2, wherein the aluminum oxide is boehmite and the composition has a Loss on Ignition (LOI) of about 0.2% to about 30%.

6. The composition of claim 1, wherein the aluminum oxide particles are crystalline.

7. The composition of claim 1, wherein the average particle length is from about 0.2 μm to about 4 μm.

8. The composition of claim 1 or 7, wherein the particles have a particle width of about 10 nm to about 250 nm.

9. The composition of claim 1, 7, or 8, wherein the particles have an aspect ratio of about 15 to about 22.

10. A process of producing aluminum oxide nanorod particles comprising:
(a) dissolving an aluminum precursor, precipitant, and optionally a polymeric additive in water to provide a solution, wherein the aluminum precursor is an aluminum nitrate, an aluminum chloride, or mixture thereof and the precipitant is selected from the group consisting of urea, NaOH, KOH, NH₃·H₂O, and mixtures thereof;
(b) mixing the solution;
(c) hydrothermally reacting the solution at a temperature of about 80° C. to about 200° C. for about 1 hour to about 24 hours to create a slurry;
(d) collecting precipitates from the slurry; and
(e) calcining the precipitates at a temperature of about 500° C. to about 1000° C. for about 1 hour to about 6 hours to provide the aluminum oxide nanorod particles having an average particle length of about 50 nm to about 10 μm and an aspect ratio of about 12 to about 25.

11. The process of claim 10, wherein the Al³⁺ concentration of the solution of step (b) is about 0.1 M to about 1.0 M.

12. The process of claim 10, wherein in step (a) an aluminum precursor and precipitant are dissolved in water to provide the solution and the precipitant is urea.

13. The process of claim 10, wherein in step (a) an aluminum precursor, precipitant, and polymeric additive are dissolved in water to provide the solution and the polymeric additive is selected from a group consisting of cetrimonium bromide, cetrimonium chloride, sodium dodecyl sulfate, polyethylene glycol and mixtures thereof.

14. The process of claim 13, wherein the polymeric additive is sodium dodecyl sulfate or cetrimonium bromide and the precipitant is urea.

15. The process of claim 10, wherein the aluminum precursor is Al(NO₃)₃·9H₂O with an oxide content of about 13.4% or is AlCl₃·6H₂O with an oxide content of about 21.1%.

16. The process of claim 10 or 15, wherein the aluminum precursor is dissolved in a concentration of about 1 g/10 mL to about 5 g/10 mL.

17. The process of claim 10 or 15, wherein the precipitant is dissolved in a concentration of about 1 g/10 mL to 6 g/10 mL.

18. The process of claim 10, wherein in step (b) the solution is mixed by stirring for about 30 mins to about 12 hours.

19. The process of claim 10, wherein in step (b) the solution is mixed by sonication and then stirring.

20. The process of claim 10, further comprising aging the slurry of step (c) in deionized water or ethanol prior to collecting the precipitates in step (d).

21. The process of claim 10 or 20, further comprising washing the precipitates of step (d) with deionized water to a conductivity of less than about 100 μS/cm prior to calcining.

22. The process of claim 10, 20, or 21, further comprising dewatering the precipitates of step (d).

23. The process of claim 22, wherein the precipitates are dewatered with ethanol and the process further comprises drying the precipitants at about 50° C. to about 100° C. for about 3 hours to about 12 hours after dewatering and before calcining.

24. The process of any one of claim 10 or 20-23, wherein in step (d) the precipitates are collected by centrifugation.

25. Aluminum oxide nanorod particles made by the process of any one of claims 10-24.
